(19) United States
(12) Patent Application Publication
(10) Pub. No.: US 2010/0040944 A1
(43) Pub. Date: Feb. 18, 2010

(54) BATTERY WITH CONTAINER FOR ALKALINE SOLUTION

(75) Inventors: Roger W. Nelson, Roswell, GA (US); Mohammad Jamal El-Hibri, Atlanta, GA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: SOLVAY ADVANCED POLYMERS, LLC, Alpharetta, GA (US)

(21) Appl. No.: 12/573,259

(22) Filed: Oct. 5, 2009

Related U.S. Application Data
(62) Division of application No. 10/480,250, filed on May 25, 2004, now abandoned.
(60) Provisional application No. 60/299,147, filed on Jun. 18, 2001.
(60) Provisional application No. 60/299,238, filed on Jun. 19, 2001.

(51) Int. Cl. H01M 2/00

(52) U.S. Cl. 429/163

(57) ABSTRACT

A container for an alkaline solution comprising a polysulfone resin and an acrylate core-shell rubber impact modifier and optionally a polycarbonate. The container can be fabricated by injection molding or thermoforming from an extruded sheet. The container is well suited as a case for aqueous KOH electrolyte batteries.

This application is a Divisional application of U.S. Ser. No. 10/480,250, filed May 25, 2004; which is a 371 of PCT/US02/19144, filed Jun. 18, 2002; and claims priority from U.S. Provisional application Ser. Nos. 60/299,147, filed Jun. 18, 2001; and 60/299,238, filed Jun. 19, 2001; the entire disclosures of each of which are herein incorporated by reference.

### TECHNICAL FIELD

This invention is directed to a container for alkaline solution, and more particularly to a container for electrical storage cells and battery cases comprising such cells.

### BACKGROUND OF THE INVENTION

Storage batteries have long been used in a wide variety of industrial and commercial applications including supplying electrical energy for automobiles, boats, tractors, and the like, and more recently have found acceptance for use in powering electric vehicles, golf carts, portable electric and electronic appliances and other mobile devices, and in uninterruptable power supplies (UPS) and in many other kinds of power systems used for electrical storage for load leveling, etc. Rechargeable lead-acid batteries and rechargeable nickel-cadmium storage batteries have been widely used for such purposes. Although lead-acid batteries are an excellent power source to drive a starter motor for an internal combustion engine, these batteries have a rather limited energy density, generally only 15 Wh/Ib, and in an electric vehicle are capable of providing a range of only 30 to 120 miles before requiring a recharge.

Considerable effort has been expended in the development of lighter, smaller battery systems that are commercially practical for use in such applications. Such batteries require cells having higher energy density, longer life, higher safety, higher reliability, easier maintenance, higher operational economy and other performance characteristics. Efforts to improve the energy density and service life have led to the development of new technologies including nickel-hydrogen batteries, nickel-zinc batteries, zinc-air batteries and the like. Batteries based on these technologies having an energy density of 40 Wh/Ib and greater and capable of powering a vehicle over 300 miles before requiring recharging have been disclosed.

Materials used in the construction of batteries are required to withstand exposure to rather severe conditions. Cells contain electrolytes that often are quite corrosive. Many applications require batteries that are able to withstand elevated temperatures without deformation and creep failure or rupture. Transportable batteries used in a variety of vehicular applications are likely to be subject to abuse, including being dropped, and must be able to withstand mechanical shock and impact without cracking or other structural failure.

Storage batteries typically comprise either sealed cells or vented cells. A characteristic of storage cell technologies is that gases may be produced during operation, depending on the amount of electrolyte and the operating temperature as well as on variations in components, chemical concentrations, and manufacturing techniques. During normal operation, a sealed cell does not permit the venting of gas to the atmosphere; a vented cell will release excess pressure by venting gas as part of its normal operation.

Small sealed alkaline rechargeable batteries comprising a steel cell can sealed at its top edge with a steel disk having a unitized polyamide gasket around its circumference may be designed for operation at pressures up to about 100 pounds per square inch absolute or even higher. Alkaline rechargeable batteries based on nickel-cadmium, nickel-zinc, nickel-air or nickel-metal hydride systems generally comprise an electrolyte that consists mainly of an alkaline solution, usually potassium hydroxide. Metal cell cans for such batteries must be constructed of metals or alloys capable of withstanding extended exposure to these harsh alkaline media.

While small, sealed alkaline batteries are widely accepted for use in electronic appliances and the like, electric vehicles, UPS systems and similar electric storage applications require rechargeable batteries having a large capacity. High capacity batteries are necessarily large and their construction presents additional design problems. Metal containers are less suitable for constructing large batteries, primarily because of weight considerations. Containers comprising rubber-based compositions, polypropylene and similar materials, because of their ability to withstand contact with sulfuric acid electrolytes, have long been employed in the manufacture of rechargeable lead-acid batteries, particularly for automotive use and similar applications. However, most such batteries are vented, or are provided with safety venting devices to maintain a low internal pressure. Although these plastic materials are generally also unaffected by contact with alkalines they are not particularly rigid. Battery containers comprising such materials will be constructed with thick walls in order to withstand the stresses normally encountered in rechargeable battery uses without undergoing deformation and possible rupture, defeating the effort to provide smaller, lighter batteries. Moreover, substantial heat is generated during operation of very high current density batteries and particularly during rapid discharge and recharge. Repeated cycles of thermal expansion and contraction significantly add to the stress on the container walls. Inasmuch as plastic materials generally are poor thermal conductors, the resulting heat buildup may produce internal temperatures that exceed the upper use temperature of the polypropylene or other plastic used in constructing the battery.

Improved injection moldable resin formulations that are strong, rigid and impact resistant, capable of resisting thermal stress and unaffected by continued contact with alkaline solutions, even at elevated temperatures, are needed to further the development of high energy density cells.

### SUMMARY OF THE INVENTION

The invention is directed to a container for alkaline solution made from materials comprising an impact modified polysulfone, such as injection molded battery cases. More particularly, resin formulations according to the invention that are useful as alkaline solution storage containers comprise a polysulfone and an acrylic impact modifier and, optionally, an arylene polycarbonate.

The alkaline solution container materials of this invention are strong and rigid, and exhibit high impact resistance properties combined with low notch sensitivity, together with high heat deflection temperature (HDT), and good resistance to extended contact with electrolytes, particularly including concentrated alkalines such as potassium hydroxide. The invented resin formulations exhibit good dimensional control and ease of fabrication by injection molding or thermoforming from an extruded sheet, providing containers and battery cases able to withstand hard use including dropping without sustaining cracking or other significant structural damage.

### DETAILED DESCRIPTION OF THE INVENTION

The invention will be described in terms of one embodiment, a battery case. Those skilled in the art would readily understand the container for alkaline solution of the instant invention is not limited to a battery case, but includes other containers for alkaline solution including alkaline solution storage containers.

Moldable compositions useful as battery case materials according to the invention will comprise a polysulfone resin and an acrylate core-shell type rubber impact modifier, and may further include a polycarbonate. Polysulfone resins useful in the practice of this invention, also known and described in the art as poly(aryl ether sulfone) resins, include polysulfones comprising repeat units made up of Bisphenol A residue moieties and diphenyl sulfone moieties as represented by the structural formula

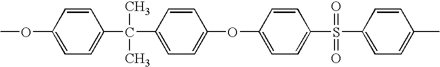

Such polysulfone resins are readily available from commercial sources, including, for example, as Udel® polysulfone (PSU) resin from Solvay Advanced Polymers, L.L.C.

Polyethersulfone, a polymer, which may be derived for example from 4,4′-dihydroxydiphenyl sulfone and 4,4′-dichlorodiphenyl sulfone and thus contain only diphenyl sulfone moieties and ether linkages in its repeat units, is also known in the art. Such a resin, frequently termed PES resin, is available from commercial sources, for example, Sumitomo Chemical under the trade name Sumikaexcel®. PES resins, as well as a variety of PES based copolymers comprising Bisphenol A residue moieties and diphenyl sulfone moieties in molar ratios less than 1:1 are used in certain embodiments of this invention. Furthermore, blends of PSU and PES as well as blends of PSU with the PES/PSU copolymers described above are also within the scope of the practice of this invention.

Methods for the preparation of poly(aryl ether sulfones) are widely known and several suitable processes have been well described in the art. The resins may generally be prepared by either of two methods, i.e., the carbonate method or the alkali metal hydroxide method. The number average molecular weight of the polysulfone will generally be in the range of 8,000 to 50,000, preferably at least 12,000, as measured by gel permeation chromatography using polystyrene standards. Weight average molecular weights of the polysulfone are typically anywhere from two to four times the number average values. The molecular weight can also be inferred from reduced viscosity data in an appropriate solvent such as methylene chloride, chloroform, N-methylpyrrolidone, or the like. The reduced viscosity for the polysulfone will be at least 0.25 dl/g, preferably at least 0.35 dl/g and, typically, will not exceed about 1.0 dl/g when measured using a polymer concentration of 0.2 g per 100 ml solution at 25° C.

The acrylate core-shell type rubber suitable for use in the practice of the invention will generally comprise from about 50 wt. % to about 95 wt. % of a first elastomeric phase and from about 50 to about 5 wt. % of a second, rigid, thermoplastic phase. The first phase is polymerized from about 75 wt. % to 99.8 wt. % C₁ to C₆ acrylate, resulting in an acrylate rubber core which is crosslinked with from about 0.1 wt. % to about 5 wt. % of a suitable cross-linking monomer and to which is added about 0.1 wt. % to about 5 wt. % of a graft-linking monomer.

Suitable alkyl acrylates include methyl acrylate, ethyl acrylate, isobutyl acrylate and n-butyl acrylate. The preferred acrylate is n-butyl acrylate. Suitable crosslinking monomers include polyacrylic and polymethacrylic esters of polyols such as butylene diacrylate and dimethacrylate, trimethylol propane trimethacrylate and the like; di- and trivinyl benzene, vinyl acrylate and methacrylate, and the like. The preferred cross-linking monomer is butylene diacrylate.

The graft-linking monomer provides a residual level of unsaturation in the elastomeric phase, particularly in the latter stages of polymerization and, consequently, at or near the surface of the elastomeric particle. The preferred graft-linking monomers are alkyl methacrylate and dialkyl maleate. The rigid thermoplastic phase may be comprised of C₁ to C₁₆ methacrylate, styrene, acrylonitrile, alkyl acrylates, alkyl methacrylate, dialkyl methacrylate and the like. Preferably, this phase is at least about 50 wt. % C₁ to C₄ alkyl methacrylate.

Methacrylate-butadiene-styrene (MBS) core shell graft copolymers formed from a rubber-elastic core comprising polybutadiene and a hard graft shell are also disclosed in the art, alone and in combination with particular stabilizer formulations, as impact modifiers for a variety of thermoplastics. The preparation of acrylate graft copolymers is well described in the art. Suitable acrylate rubber modifiers are available commercially, including an acrylate rubber modifier obtainable from the Rohm & Haas Corporation, Philadelphia, Pa. under the tradename Paraloid® EXL-3361.

Polycarbonates suitable for use in the practice of the invention are high molecular weight, thermoplastic, aromatic polymers, including homopolycarbonates, copolycarbonates and copolyestercarbonates and mixtures thereof, which have weight average molecular weights of about 8,000 to more than 200,000, preferably of about 20,000 to about 80,000 and an inherent viscosity (I.V.) range of about 0.30 to 1.0 dl/g as measured in an appropriate solvent at a concentration of 0.2 g/100 ml at 25° C.

The polycarbonates may conveniently be derived from dihydric phenols and carbonate precursors. Typical of the dihydric phenols suitable for use in producing polycarbonates are 2,2-bis(4-hydroxyphenyl)propane (Bisphenol A), bis(4-hydroxyphenyl)methane, 2,2-bis(4-hydroxy-3-methylphenyl)propane, 4,4-bis(4-hydroxyphenyl)heptane, 2,2-(3,5,3′,5′-tetrachloro-4,4′-dihydroxyphenyl) propane, 2,2-(3,5,3′,5′-tetrabromo-4,4′-dihydroxyphenyl)-propane, and 3,3′-dichloro-4,4′-dihydroxydiphenyl methane. Other suitable dihydric phenols are also available, including those disclosed in U.S. Pat. Nos. 2,999,835; 3,038,365; 3,334,154; and 4,131,575. The carbonate precursor employed may be a carbonyl halide such as phosgene, a carbonate ester or a haloformate.

The polycarbonates may be manufactured by a variety of widely known processes such as, for example, by reacting a dihydric phenol with a carbonate precursor such as diphenyl carbonate or phosgene in accordance with methods set forth in the above-cited literature and in U.S. Pat. Nos. 4,018,750 and 4,123,436, or by transesterification processes such as are disclosed in the U.S. Pat. No. 3,153,008, as well as other processes known to those skilled in the art.

Suitable polycarbonate resins are also readily available from a variety of commercial sources, including poly(Bisphenol A carbonate) resins available as Lexan® polycarbonate resins from the General Electric Company and Makrolon® polycarbonate resins from Bayer Corporation.

Impact modified compositions suitable for use as battery materials will include from about 97 wt. % to about 88 wt. % polysulfone and from about 3 wt. % to about 12 wt. % of the impact modifying acrylate rubber.

The high impact strength polysulfone compositions may further comprise a polycarbonate. These ternary blends, stated in terms of the total of weight of the three resin components, will comprise from about 70 wt. % to about 92 wt. % polysulfone, from about 5 wt. % to about 25 wt. % of the polycarbonate, and from about 3 wt. % to about 12 wt. %, preferably about 5 wt. % to about 10 wt. % acrylate core-shell type rubber.

It is essential that the battery case material be readily injection moldable to provide molded containers with adequate part filling and packing, and without part sticking in the mold or tool. Hence, the impact modified polysulfone formulations in certain embodiments intended for use in the production of battery cases and containers further contain processing aids, including an effective amount, preferably from about 0.05 wt. % to about 2 wt. % based on total weight of resin components, of one or more mold release lubricants such as, for example, metal stearates, hydrocarbon waxes, polysiloxanes, perfluorinated compounds or polymers (e.g. polytetrafluoroethylen (PTFE)) and the like. The weight of mold release agent can also be based on the total weight of the container.

The polysulfone formulations may be further compounded to include up to about 60 wt. % based on the total weight of the container of various additives to improve or modify various chemical and physical properties. Examples of such additives include flame retardants, anti-oxidants, light stabilizers, colorants, fillers and reinforcing agents. Suitable as reinforcing agents are glass fibers and carbon fibers including graphitic fibers. Metal fibers, alumina and aluminum silicate fibers, aluminum oxide fibers, rock wool fibers and the like may also be found useful for particular applications. Representative filler materials include particulate and powdered forms of calcium silicate, silica, clays, talc, mica, carbon black, titanium dioxide, wollastonite, polytetrafluoroethylene, graphite, alumina trihydrate, sodium aluminum carbonate, barite and the like. The appropriate types and levels of such additives will depend on processing techniques and on the end use envisioned for the molded container or case, and can readily be determined by those skilled in the resin compounding arts.

The polysulfone formulations may be compounded using any of the variety of compounding and blending methods well-known and commonly used in the resin compounding arts. Conveniently, the polysulfone and modifying components, in powder, pellet or other suitable form, may be melt compounded at temperatures effective to render the resinous components molten using a high shear mixer, e.g., a twin-screw extruder, to obtain a desirably uniform blend. The components may be first combined in solid form, such as powder or pellets, prior to melt compounding to facilitate mixing. Particulates, fibers and other additives may be incorporated into one or more of the components prior to combining with the remaining components, or the components may be physically mixed in powder or pellet form using conventional dry-blending methods and then extrusion compounded. Plasticating the resin in a compounding extruder and feeding the additives, particulates or fibers to the molten composition through a port in the extruder as is also commonly practiced in the art may be found useful in compounding the compositions of this invention.

The invention will be better understood through consideration of the following examples, provided by way of illustration.

### Examples

The resin components employed in the examples include:

Polysulfone: Poly(aryl ether sulfone) containing Bisphenol A residue moieties and diphenyl sulfone moieties, obtained as Udel P-3703 NT polysulfone resin from Solvay Advanced Polymers, L.L.C.

Polycarbonate: Poly(Bisphenol A carbonate), obtained as Makrolon 3108 bisphenol A polycarbonate resin from Bayer AG.

Rubber: Acrylate core-shell type rubber, obtained as Paraloid EXL-3361 acrylate graft copolymer rubber modifier from Rohm and Haas Corporation.

Lube 1: zinc stearate mold release lubricant.

Lube 2: hydrocarbon mold release lubricant, obtained as Hostalube 165.

Stabilizer: Irganox 1010 thermal stabilizer from Ciba Geigy Company

Compounding was accomplished by first dry-blending dried resin with the additives then feeding the blend to a ZSK-40 vacuum-vented corotating partially intermeshing twin screw extruder using screw speeds of 220-232 rpm, melt temperatures in the range 340°-350° C., and die temperatures in the range 330°-335° C. The compounded polymer was extruded through a strand die into water, then chopped to form pellets. The various components as well as the parts thereof in each of the blends are indicated in Table 1 below.

TABLE 1
Toughened Polysulfone Formulations

Example No.:

| | | 1 | 2 | 3 | 4 |
|---|---|---|---|---|---|
| Polysulfone | pbw | 94.9 | 89.9 | 93.7 | 87.7 |
| Rubber | pbw | 5.0 | 5.0 | 6.0 | 6.0 |
| Lube 1 | pbw | — | — | 0.2 | — |
| Lube 2 | pbw | — | — | — | 0.2 |
| Polycarbonate | pbw | — | 5.0 | — | 6.0 |
| Stabilizer | pbw | 0.1 | 0.1 | 0.1 | 0.1 |

The formulations of the examples in Table 1 were injection molded to provide test specimens. The formulations of Examples 1 and 2 lack mold release lubricant and were difficult to mold without sticking. The mechanical and physical properties determined for the molded specimens are summarized in the following Table 2.

TABLE 2
Physical and Mechanical Properties of
Injection Molded Polysulfone Formulations

| | | Example No.: | | | |
|---|---|---|---|---|---|
| | | 1 | 2 | 3 | 4 |
| Tensile Yield Strength | (kpsi) | 10.0 | 10.2 | 10.1 | 9.6 |
| Tensile Modulus | (ksi) | 364 | 404 | 354 | 332 |
| Break Elongation | (%) | 9.2 | 24 | 26 | 51 |
| Flexural Strength | (kpsi) | 16.6 | 15.6 | 15.5 | 15.2 |
| Flexural Modulus | (ksi) | 378 | 360 | 382 | 374 |
| Notched Izod | (ft-lb/in) | 1.9 | 2.5 | 3.0 | 13.9 |
| No Notch Izod | (ft-lb/in) | NB | NB | — | — |
| Tensile Impact | (ft-lb/in²) | 148 | 194 | 164 | 216 |
| Dynatup Impact, Total | (ft-lb) | 45.9 | — | 46.5 | 44.4 |
| Energy | | | | | |
| Dynatup Impact, Max. | (lb) | 1263 | — | 1282 | 1194 |
| Load | | | | | |
| HDT @264 psi | (° C.) | 175.3 | 172.0 | 168.5 | 165.8 |
| Specific Gravity | | 1.23 | — | 1.23 | 1.22 |
| Melt Flow @320° C., | (dg/min) | 8.9 | — | 10.2 | 8.7 |
| Melt Stability | | 0.58 | 0.47 | 0.43 | 0.38 |
| Viscosity Ratio | | | | | |

Notes:
Tensile properties by ASTM D-638; Flexural properties by ASTM D-790;
Izod Impact by ASTM D-256 (NB = No break);
Tensile Impact by ASTM D-1822;
Dynatup by ASTM D-3763;
HDT by ASTM D-648, molded bars, ⅛ in. thick;
Melt flow by ASTM D-1238;
Melt stability viscosity ratio is ratio of 40 min. melt viscosity to 10 min. melt viscosity, 343° C., 50⁻¹ sec shear rate

### Potassium Hydroxide Resistance

KOH resistance was tested by immersion in an aqueous solution of 20 wt. % KOH at 70° C. Injection molded tensile bars were immersed in the KOH bath without stress. Bars were removed weekly and tensile properties were measured to monitor the effect of KOH on the basic mechanical properties of the materials. The formulations tested and the test results can be found in the following Table 3.

TABLE 3

| | | | | |
|---|---|---|---|---|
| | | | | Break |
| Tens. Yield | Tens. | Yield | Break | Elong. |
| Strength | Mod. | Elong. | Elong. | Std. |
| (kpsi) | (ksi) | (%) | (%) | Dev. |

Example 1

| | | | | | |
|---|---|---|---|---|---|
| As molded: | 10.4 | 382 | 5.3 | 29 | 7 |
| 1 week: | 10.1 | 367 | 5.1 | 48 | 64 |
| 2 weeks: | 10.2 | 366 | 5.0 | 35 | 14 |
| 3 weeks: | 10.3 | 388 | 5.15 | 28 | 24 |
| 4 weeks: | 10.0 | 374 | 4.9 | 34 | 4 |
| 8 weeks: | 10.4 | 398 | 4.9 | 22 | 11 |

Example 2

| | | | | | |
|---|---|---|---|---|---|
| As molded: | 10.3 | 371 | 5.4 | 32 | 24 |
| 1 week: | 10.4 | 381 | 5.2 | 59 | 44 |
| 2 weeks: | 10.3 | 379 | 5.1 | 62 | 50 |
| 3 weeks: | 10.2 | 383 | 5.0 | 14 | 7 |
| 4 weeks: | 10.3 | 384 | 5.2 | 46 | 45 |
| 8 weeks: | 10.55 | 380 | 4.7 | 18 | 8 |

It will be apparent from a consideration of the data presented in Table 3 that the retention of mechanical properties after exposure to the hot KOH solution is very good. Tensile strength, tensile modulus (stiffness), and yield elongation remain essentially unchanged after eight weeks of exposure. Tensile elongation at break drops somewhat, but it is still around 20% after eight weeks of exposure, which is a respectable elongation.

Electron microscopy examination of the surfaces of tensile bars before and after 4 weeks of exposure to KOH revealed no significant differences between the exposed samples and the controls, and found no significant differences between the formulations containing polycarbonate and those without polycarbonate.

Polycarbonate resins are known to degrade in water and in alkaline environments. Thus, it is surprising that in this test both the polysulfone/rubber formulation, Example 1, and the polysulfone/rubber/polycarbonate formulation, Example 2, exhibited almost identical resistance to hot solutions of high alkalinity. It appears that at the very low concentration of polycarbonate in the formulation, KOH has no adverse effects on the polycarbonate component. Possibly the polycarbonate is fully encapsulated in the base resistant polysulfone phase. Further, the rubber appears to be similarly protected by the polysulfone.

Formulations of Examples 1 and 2 were successfully injection molded to provide battery cases. The cases withstood multiple drops without cracking or significant structural damage.

The invention will thus be seen to include an injection molded battery case comprising an impact modified polysulfone, and more particularly comprising a polysulfone resin and an acrylate core-shell type rubber impact modifier, and may further include a polycarbonate. The impact modified polysulfone formulations suitable for use according to the invention will include from about 97 wt. % to about 88 wt. % polysulfone and from about 3 wt. % to about 12 wt. % of the impact modifying acrylate rubber, and preferably will further include a mold release lubricant, for example a metal stearate, a hydrocarbon wax or the like. The compositions may optionally include from about 5 wt. % to about 20 wt. %, based on total weight of polysulfone and impact modifier, of a polycarbonate. Stated in terms of the three resin components, where the formulation further comprises a polycarbonate the ternary blends will comprise from about 70 wt. % to about 92 wt. % polysulfone, from about 5 wt. % to about 25 wt. % of the polycarbonate, and from about 3 wt. % to about 12 wt. %, preferably from about 5 wt. % to about 10 wt. %, acrylate core-shell type rubber, preferably further including from 0.05 wt. % to about 2 wt. % mold release lubricant.

The molded battery cases of this invention are capable of withstanding severe impact and other substantial abuse without cracking or structural failure, and are unaffected by extended exposure to corrosive electrolyte at elevated temperatures, particularly including caustic or other corrosive alkaline solutions such as, for example, potassium hydroxide. Generally, the battery case materials suitable for use in the practice of this invention will withstand eight weeks exposure to 20 wt. % aqueous KOH at a temperature of 70° C. with no more than 10% change in tensile strength or in tensile modulus.

Although the invention has been described and exemplified using particular formulations, it will be understood that formulations containing polysulfone resins, acrylate rubber impact modifiers and polycarbonates other than those exemplified may also be found useful for these purposes. Those skilled in the art will readily understand that the examples set forth herein above are provided by way of illustration, and are not intended to limit the scope of the invention defined by the appended claims.

1-16. (canceled)

17: A battery, said battery comprising an injection-molded battery case, said battery case comprising a polysulfone resin and an an acrylate core-shell rubber impact modifier.

18: The battery as claimed in claim 17, wherein said battery is a storage battery.

19: The battery as claimed in claim 17, wherein said battery is an alkaline rechargeable battery.

20: The battery of claim 17, further comprising an alkaline solution held in said battery case.

21: The battery of claim 17, wherein said battery case comprises from about 88 wt. % to about 97 wt. % of the polysulfone and from about 3 wt. % to about 12 wt. % of the acrylate core-shell rubber impact modifier based on the total weight of the polysulfone and the rubber impact modifier.

22: The battery of claim 17, wherein said polysulfone is a poly(aryl ether sulfone).

23: The battery of claim 22, wherein said poly(aryl ether sulfone) comprises repeat units of bisphenol A residues and diphenyl sulfone moieties as represented by the structural formula:

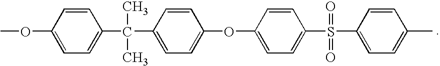

24: The battery of claim 22, wherein said poly(aryl ether sulfone) is polyethersulfone.

25: The battery of claim 22, wherein said poly(aryl ether sulfone) is a blend of a polymer comprising repeat units of bisphenol A residues and diphenyl sulfone moieties as represented by the structural formula: 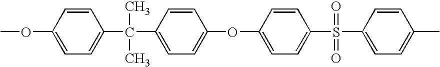
and polyethersulfone.

26: The battery of claim 22, wherein said poly(aryl ether sulfone) is a blend of acopolymer comprising repeat units of bisphenol A residues and diphenyl sulfone moieties as represented by structural formula: 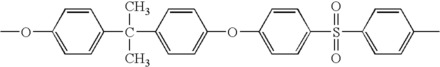
and polyethersulfone.

27: The battery of claim 17, wherein said battery case further comprises a polycarbonate.

28: The battery of claim 27, wherein said polycarbonate is a poly(bisphenol A carbonate).

29: The battery of claim 27, wherein said battery case comprises from about 70 wt. % to about 92 wt. % of the polysulfone, from about 5 wt. % to about 25 wt. % of the polycarbonate, and from about 3 wt. % to about 12 wt. % of the acrylate core-shell rubber impact modifier based on the total weight of the polysulfone, polycarbonate, and rubber impact modifier.

30: The battery of claim 17, wherein said battery case further comprises a perfluorinated polymer.

31: The battery of claim 30, wherein said perfluorinated polymer is present in an amount of up to about 2 wt. % based on the total weight of resin components.

32: The battery of claim 27, wherein said battery case further comprises a perfluorinated polymer.

33: The battery of claim 32, wherein said perfluorinated polymer is present in an amount of up to about 2 wt. % based on the total weight of resin components.
